(19) United States
(12) Patent Application Publication
(10) Pub. No.: US 2006/0188014 A1
(43) Pub. Date: Aug. 24, 2006

(54) Video coding and adaptation by semantics-driven resolution control for transport and storage

(76) Inventors: M. Reha Civanlar, Istanbul (TR); A. Murat Tekalp, Rochester, NY (US)

Correspondence Address: LACASSE & ASSOCIATES, LLC, 1725 DUKE STREET, SUITE 650, ALEXANDRIA, VA, 22314, US

(21) Appl. No.: 11/062,849

(22) Filed: Feb. 23, 2005

(51) Int. Cl. H04N 11/04; H04B 1/66; H04N 11/02; H04N 7/12

(52) U.S. Cl. 375/240.03

(57) ABSTRACT

A method and system for modifying the spatial and/or temporal resolution and/or signal to noise ratio of temporal and/or spatial segments of compressed video based on semantic properties of the video content to adapt the compressed video size for transport and storage applications.

### BACKGROUND OF THE INVENTION

1. Field of Invention

The present invention relates generally to the field of video compression. More specifically, the present invention is related to adapting the compressed video size for transport and storage applications.

2. Discussion of Prior Art

Efficient video compression is vital for multimedia transport and storage. The bandwidth allocated for video transport or the storage space allocated for video is usually limited and therefore should be used very effectively. In many applications e.g., wireless video transport, using the available resources, achieving an acceptable video quality may not be possible even with the high compression rates made available by the latest compression techniques [H.264].

An approach for better use of the available resources for transporting or storing video is content based processing. The article entitled, “Real-Time Content-Based Adaptive Streaming of Sports Video” by Chang et al., describes content based rate allocation, where the input video is first divided into temporal segments, each of two levels of importance are assigned: high and low. The segments with high importance are encoded using video compression with one bandwidth and the low importance segments are encoded as still images and audio. The published U.S. patent application to Chang et al. (2004/0125877) provides another way to code the low importance segments, allocating lower bandwidth to low importance segments than to high importance segments. However, means for achieving this lower bandwidth is not specified.

For video content without any specific context, such as movies or home videos, the article entitled, “Predicting Optimal Operation of MC-3DSBC Multi-Dimensional Scalable Video Coding Using Subjective Quality Measurement” by Wang et al., describes a trade-off between temporal resolution and signal to noise ratio (SNR) based on the input video's signal level properties without considering semantics.

For video with a known context such as a soccer game, TV news, etc., dividing the input video into temporal segments with two or more priorities may be performed automatically as described in the article entitled, “Automatic Soccer Video Analysis and Summarization” by Ekin et al.

U.S. Pat. No. 6,810,086, assigned to AT&T Corp., describes a method of performing content adaptive coding and decoding wherein the video codec adapts to the characteristics and attributes of the video content by filtering noise introduced into the bit stream.

Current methods suggest changing the target bitrates of the compressors used during video coding that effectively change only the SNR of the output segments. For video input with known context, after the input video gets segmented, automatically or manually, into parts to which different importance or relevance levels are assigned, a technique for changing the bitrate allocations to these segments is needed.

Whatever the precise merits, features, and advantages of the above cited references, none of them achieves or fulfills the purposes of the present invention.

### SUMMARY OF THE INVENTION

A method and system for adaptation of compressed video bandwidth to time-varying channels by selecting appropriate spatial and temporal resolutions and SNR based on semantic video content properties. The method and system is applied to adaptation of non-scalable, scalable, pre-stored and live coded video.

### BRIEF DESCRIPTION OF THE DRAWINGS

FIG. 1 illustrates the overall concept of content adaptive video coding, as per an exemplary embodiment of the present invention.

FIG. 2 illustrates an exemplary system using a non-scalable video encoder processing all segments simultaneously.

FIG. 3 illustrates an exemplary system using an embedded video encoder processing one segment at a time.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

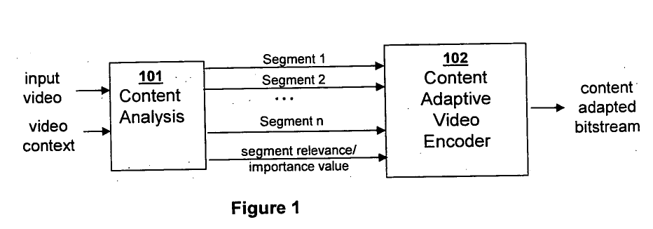

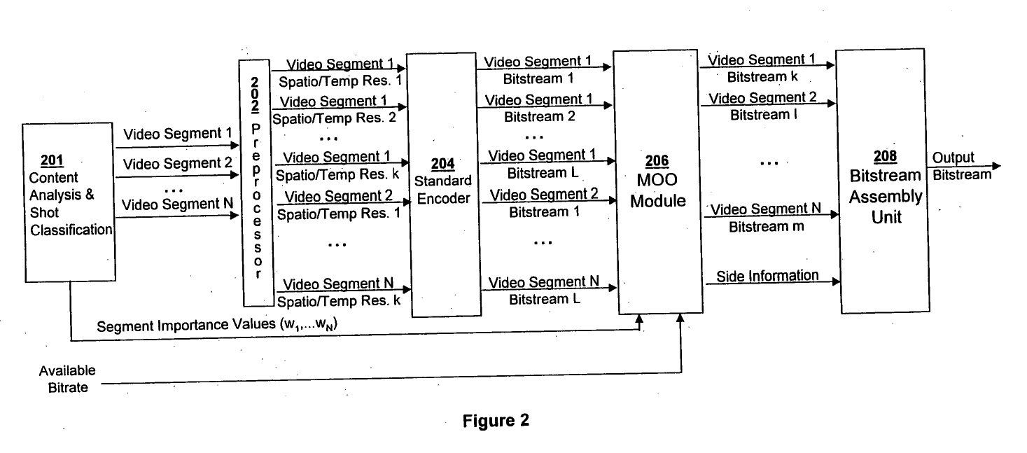

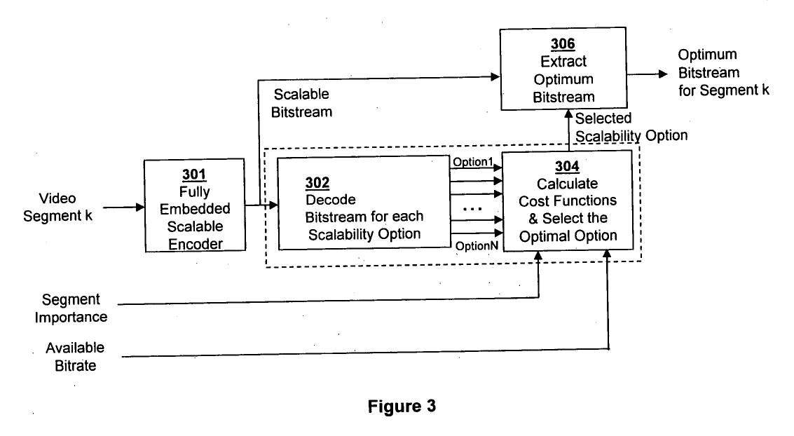

FIG. 1 illustrates an overall conceptual diagram of content adaptive video coding system. Video is input into block 101 where content analysis is performed based on the context of the video. Video is decomposed into spatio-temporal segments (regions, scenes, shots) and each spatio-temporal segment is assigned a semantic relevance/importance value prior to the encoding stage. These segments are input into a content adaptive video encoder block 102 that can encode each segment one by one or all segments simultaneously at different spatial (frame size) and/or temporal (frame rate) resolution with different encoding/scalability parameters depending on its semantic relevance and perceptual distortion introduced. Two different exemplary implementations with a non-scalable encoder processing all segments simultaneously and with a scalable encoder processing each segment one by one are demonstrated in FIGS. 2 and 3, respectively.

Different encoding parameters or scalability options yield different types of distortions. For example, SNR scalability results in blockiness due to block motion compensation and flatness due to large quantization parameter at low bitrates. On the other hand, spatial resolution reduction results in blurriness due to spatial low-pass filtering in the interpolation for display, and temporal resolution reduction results in temporal blurring due to temporal low-pass filtering and motion jerkiness. Because the PSNR (peak signal to noise ratio) measure is inadequate to capture all these distortions or distinguish between them, four separate measures are employed; namely flatness, blockiness, blurriness, and temporal distortion measures, to quantify the effects of various spatial, temporal and quantization parameter tradeoffs.

A. Flatness Measure

Although flatness degrades visual quality, it does not affect the PSNR (peak signal to noise ratio) significantly. Hence, a new objective measure for flatness based on local variance of regions other than edges is used. First, major edges using the Canny edge operator [L. Shapiro and G. Stockman, Computer Vision, Prentice-Hall, Upper Saddle River, N.J., 2000] are found, and the local variance of 4×4 blocks that contain no significant edges are computed. The flatness measure is then defined as:

$${D}_{flat} = \{ \begin{matrix}\frac{{\sum }_{i} [ {σ}_{org}^{2} ( i ) - {σ}_{d}^{2} ( i ) ]}{N} & if {σ}_{avg}^{2} ≺ t \\ 0 & otherwise\end{matrix}$$

where σ_{org}² (i) and σ_{d}² (i) denote the variance of 4×4 blocks on original (reference) and decoded (distorted) frames, respectively, N is the number of 4×4 blocks in a frame, and t is a threshold value which is experimentally determined. The hard-limiting operation serves two purposes: i) measures flatness in low texture areas only, where flatness is the most visible, and ii) provides spatial masking of quantization noise in high texture areas.
B. Blockiness Measure

Several blockiness measures exist to assist PSNR in the evaluation of compression artifacts under the assumption that the block boundaries are known a priori. The blockiness metric is defined as the sum of the differences along predefined straight edges scaled by the texture near that area. When using overlapped block motion compensation and/or variable size blocks, location and size of the blocky edges are no longer fixed. To this effect, first the locations of the blockiness artifacts should be found. Straight edges detected in the decoded frame, which do not exist in the original frame, are treated as blockiness artifacts. Canny edge operator is used to find such edges. Any edge pixels that do not form straight lines are eliminated. A measure of texture near the edge location, which is included to consider spatial masking, is defined as:

$${TM}_{hor} ( i ) = {\sum }_{m = 1}^{3} {\sum }_{k = 1}^{L} \vert f ( i - m , k ) - f ( i - m + 1 , k ) \vert + {\sum }_{m = 1}^{3} {\sum }_{k = 1}^{L} \vert f ( i + m , k ) - f ( i + m + 1 , k ) \vert$$

where, f denotes the frame of interest, and L is length of the straight edge. L is set to 16. The blockiness of the i^{th} horizontal straight edge can be defined as:

$${Block}_{hor} ( i ) = \frac{{\sum }_{k = 1}^{k = L} \vert f ( i , k ) - f ( i - 1 , k ) \vert}{1.5 \cdot {TM}_{hor} ( i ) + {\sum }_{k = 1}^{k = L} \vert f ( i , k ) - f ( i - 1 , k ) \vert}$$

The blockiness measure for all horizontal block borders, Blockₕₒᵣ, is defined as:

$${BM}_{hor} = {\sum }_{i ∈ All horizontal block boundaries} {Block}_{hor} ( i )$$

Blockiness measure for vertical straight edges BMᵥₑᵣₜ can be defined similarly. Finally, total blockiness metric D_{block} is defined. as:
D_{block}=BMₕₒᵣ+BMᵥₑᵣₜ
C. Blurriness Measure

Blurriness is defined in terms of change in the edge width. Major vertical and horizontal edges are found by using the Canny operator, and the width of these edges are computed by finding local minima around them. The blurriness metric is then given by:

$${D}_{blur} = \frac{{\sum }_{i} ( {Width}_{d} ( i ) - {Width}_{org} ( i ) )}{{\sum }_{i} {Width}_{org} ( i )}$$

where Width_{org} (i) and Width_{d} (i) denote the width of the i^{th} edge on the original (reference) and decoded (distorted) frame, respectively. Edges in the still regions of frames are taken into consideration. The threshold for change detection can be selected as desired.
D. Temporal Jerkiness Measure

In order to evaluate the difference between temporal jerkiness of the decoded and original video with full frame rate, the sum of magnitudes of differences of motion vectors over all 16×16 blocks at each frame (without considering the replicated frames) are computed:

$${D}_{jerk} = \frac{{\sum }_{i} \vert {MV}_{d} ( i ) - {MV}_{org} ( i ) \vert}{N} .$$

where MV_{org}(i) ,MV_{d}(i) and N denote the i^{th} element of the motion vector of the original 16×16 block, motion vector of the 16×16 block of interest and the number of 16×16 blocks in one frame respectively.

In cases where bitrate reduction is achieved by spatial and temporal scalability, the resulting video must be subject to spatial and/or temporal interpolation before computation of distortion. Then, the distortion between the original and decoded video depends on the choice of the interpolation filter. For spatial interpolation, the inverse of the Daubechies 9-7 filter is used, which is an interpolating filter for signals down sampled using the wavelet filter. Temporal interpolation should ideally be performed by MC filters. However, when the low frame rate video suffers from compression artifacts such as flatness and blockiness, MC filtering is not very successful. On the other hand, simple temporal filtering, without MC, results in ghost artifacts. Hence, a zero order hold (frame replication) for temporal interpolation is employed.

Streaming applications transmitted in a lossless, constant bandwidth channel, where the average (target) source coding rate is fixed for the duration of the video, initial delay Tᵢ is a function of the channel bandwidth BW, total duration of the video TD, and the average encoding rate \overline{R}. Different target bitrates, R₁,R₂, . . . , R_{N} are assigned to different temporal segments. Hence, for continuous playback, the receiver buffer must not get empty at any time after an initial pre-roll delay for the duration of transmission, which can be modeled as
BW·Tₚ+BW·t≧\overline{R}(t)·t for 0≦t≦TD
where \overline{R}(t)denotes the average bitrate of the encoded video until time (frame) t. Therefore, continuous playback condition can be guaranteed by

$${T}_{p} \geq {max}_{t} [ ( \frac{ \overline{R} ( t )}{BW} - 1 ) \cdot t ] for 0 \leq t \leq TD$$

The initial delay to guarantee continuous playback varies by how target bitrates are assigned to different temporal segments, although the average bitrate and duration of the clip are the same. As a result, in streaming applications classical rate-distortion optimization (RDO) solution does not necessarily guarantee minimum pre-roll delay under continuous playback constraint. Hence, there is a need for a new delay-distortion optimization (DDO) solution.

A potential formulation of the delay-distortion minimization problem can be

$$min ( {T}_{p} ) = {min}_{ \overline{R} ( {t}_{max} )} \{ {max}_{t} [ ( \frac{ \overline{R} ( t )}{BW} - 1 ) \cdot t ] \}$$

subject to
Dᵢ≦Dᵢ^{max},i=1, . . . ,N
where Dᵢ denotes the coding distortion for temporal segment i and Dᵢ^{max} is specified for each temporal segment. In this formulation, the minimization of rate in the classical rate-distortion optimization has been replaced by minimization of pre-roll delay.

A possible drawback of this formulation is that it may result in underutilization of the channel bandwidth if the minimum value of Tₚ is zero, with the trivial solution such that Dᵢ=Dᵢ^{max}, i=1, . . . , N where, each segment is encoded with the worst allowable distortion. This can be avoided by formulating the problem of finding the optimal set of encoding parameters for each shot as a multi-objective optimization (MOO) problem.

Thus, assuming a fixed bandwidth channel for video transmission, a selection of the best encoding parameters for each segment of the video, as a multiple objective optimization problem to minimize perceptual coding distortion and initial delay at the receiver under continuous playback and maximum perceptual distortion (per segment) constraints is formulated.

In the MOO formulation, the optimal set of parameters for each segment is chosen by solving a constrained, multi objective optimization problem to minimize the initial playback delay and the weighted distortion at the receiver subject to maximum acceptable distortion constraints Dᵢ^{max}:

$$min ( {T}_{p} ) = {min}_{ \overline{R} ( {t}_{max} )} \{ {max}_{t} [ ( \frac{ \overline{R} ( t )}{BW} - 1 ) \cdot t ] \}$$

$$min ( D ) = {min}_{{y}_{i} , {D}_{i}} \{ {\sum }_{i = 1}^{N} {w}_{i} \cdot {D}_{i} \cdot {y}_{i} \cdot {TD}_{i} \}$$

jointly subject to
Dᵢ≦Dᵢ^{max},i=1, . . . ,N
where TDᵢ and BW are the duration of the i^{th} video segment and the available bandwidth of the channel respectively, and yᵢ is a binary variable denoting if the specific shot is actually encoded for transmission (yᵢ=1) or skipped (yᵢ=0). The minimization is over the value of yᵢ and Dᵢ for each temporal segment i.

In a modified formulation, the optimal set of encoding parameters for each segment is again chosen by solving a constrained, multi objective optimization problem to minimize the initial playback delay and the weighted distortion at the receiver. However, this time the objective function for initial delay does not take care of continuous playback. Instead, a new constraint that guarantees continuous playback is introduced. Maximum acceptable distortion constraints still remain valid. This simplified formulation can be stated as:

$${min}_{j} ( {t}_{w} ) = {min}_{j} \{ {\sum }_{i = 1}^{N} \frac{{R}_{i}^{j} - BW}{BW} {y}_{i}^{j} \cdot {TD}_{i} \}$$

$${min}_{j} ( D ) = {min}_{j} \{ {\sum }_{i = 1}^{N} {w}_{i , eff} \cdot {D}_{i}^{j} \cdot {y}_{i}^{j} \cdot {TD}_{i} \}$$

jointly subject to
Dᵢ^{j}≦Dᵢ^{max},i=1, . . . ,N
and

$${t}_{w} \cdot BW - {\sum }_{i = 1}^{n} {y}_{i}^{j} ( {R}_{i}^{j} - BW ) {TD}_{i} \geq 0 , n = 1 , … , N$$

Here, the variable Rᵢ^{j}, the average rate for the i^{th} segment, is a function of the coding parameters, that is, the quantization step-size, frame rate and spatial resolution. Again, the minimization is over the value of j=1, . . . ,k for each temporal segment i. The last constraint guaranties that we never stop streaming after an initial waiting time.

A dynamic programming solution for MOO problem is formulated as below. Assuming that each of the N segments, with semantic relevance factors {W₁,W₂, . . . ,W_{N}}, has been coded off-line using k combinations of spatial resolutions, frame rates, and quantization parameters, and the perceptual distortion measures achieved for each segments are stored:
{D₁¹,D₁², . . . ,D₁^{k},D₂¹,D₂², . . . ,D₂^{k}, . . . ,D_{N}¹,D_{N}², . . . ,D_{N}^{k}}
where, each Dᵢ^{j} is a weighted sum of the blockiness, PSNR and the jitter measures (increasing PSNR has a negative effect on distortion). The jitter measure due to insufficient frame rate is computed as the difference of average motion vector lengths between full frame rate and the current frame rate.
Bitrates corresponding to the above distortions:
{R₁¹,R₁², . . . ,R₁^{k},R₂¹,R₂², . . . ,R₂^{k}, . . . ,R_{N}¹,R_{N}², . . . ,R_{N}^{k}}
are also stored for each combination of these encoding parameters. The quantization step sizes for both the intra and inter coded frames are also determined.

One of the well known solution techniques for multi objective dynamic programming problems as the one above is finding an optimal point for each of the objective functions individually while letting the other objective function grow freely and, then, finding the best compromise by examining all feasible points in between these individually optimal points. The initial delay objective function is ignored first and the encoding parameter combination that gives the minimum distortion is found. Clearly, this procedure returns the encoding parameters that result in highest bitrates for each video segment and this combination's overall distortion measure is referred to as Dᵤ. Secondly, the minimum distortion objective function is ignored and the encoding parameter combination that gives the minimum pre-roll time. Obviously, this will give us the encoding parameter combination resulting in maximum allowable distortion values found and its overall waiting time is denoted by Tᵤ. The optimal solution is then found as the closest point to the utopia point (Dᵤ,Tᵤ) among feasible solutions using the Euclidian distance measure. An example MOO problem and its solution have been demonstrated in the Appendix. Software packages exist for the solution of such problems.

System for Using a Non-Scalable Video Coder:

FIG. 2 illustrates a non-scalable video coder in one embodiment of the present invention. The content analysis and shot classification module 201 performs shot boundary detection and classification of each shot into certain pre-defined semantic content types. The output of the module is N segments each with a relevancy measure Wᵢ, i=1, . . . ,N. The pre-processor 202 converts each segment into all of k pre-selected spatial and temporal resolution format choices. The standard encoder 204 encodes each input segment Iᵢ with all possible encoding parameter sets (spatial/temporal resolution and quantization parameter choices) resulting in L×N output bitstreams. The output of the standard encoder for the i^{th} segment and j^{th} encoding parameter set is a bitstream with rate-distortion pair (Rᵢ^{j},Dᵢ^{j}). After this stage, all rate-distortion pairs for each segment along with user-defined relevancy levels and available channel bandwidth information is fed to the MOO (multiple objective optimization) module 206. The optimal encoding strategy is then decided to minimize both pre-roll delay and overall perceptual distortion of the transmitted video. Spatial resolution, frame rate and quantization parameter of each segment may be embedded into the transmitted bitstream or sent as side information by the bitstream assembly unit 208 via a QoS channel.

In a standard H.264 encoder, the HRD (Hypothetical Reference Decoder) model assumes that the video will be drained at by a CBR (Constant Bit Rate) channel with rate equal to the video encoding rate. In the present invention, the target bitrates assigned to each segment vary, and the target encoding bitrate can be more than the CBR channel rate for these segments. Thus, an additional encoder buffer will be needed to store the excess bits produced. Because bits transmitted during the pre-roll time need to be stored at. the decoder side, an identical additional buffer will be required at the decoder as well to ensure proper operation of the variable target rate system of the present invention.

System for Using a Fully Embedded Scalable Video Coder:

The input video is divided into temporal segments and segments are classified according to content types using a content analysis algorithm. A list of scalability operators for each video segment is presented. Next, the problem of selecting the best scalability operator for each temporal video segment among the list of available scalability options, such that the optimal operator yields minimum total distortion, which is quantified as a linear combination of the four individual distortion measures is presented. Finally, determination of the coefficients of the linear combination, which quantifies the total distortion, as a function of the content type of the video segment is addressed. For example, blurriness is more objectionable in close-medium shots; flatness is more disturbing in far shots; and motion jerkiness is more noticeable when there is global camera motion.

A. Scalability Options

There are three basic scalability options: temporal, spatial, and SNR scalability. Combinations of scalability operators to allow for hybrid scalability modes are also considered. Six combinations of scaling options for each temporal segment are listed below:

1. SNR only scalability

2. (Spatial)+SNR scalability

3. (Temporal)+SNR scalability

4. (Spatial+temporal)+SNR scalability

5. (2 level temporal)+SNR scalability

6. (2 level temporal+spatial)+SNR scalability

where, the parenthesis indicates the spatial and temporal resolution extracted for each scaling option. For example, option four denotes that the extracted layer corresponds to one level temporal and one level spatial scaling that produces half the original frame rate and half the original spatial resolution; and, option five produces one quarter of the original frame rate and half the original spatial resolution.

B. Selection of Optimum Scalability Option for Each Temporal Segment

Most existing methods for adaptation of the video coding rate to time-varying channels are based on adaptation of the SNR (quantization parameter) only, because: i) it is not straightforward to employ the conventional rate-distortion framework for adaptation of temporal, spatial and SNR resolutions simultaneously; ii) PSNR is not an appropriate cost function for considering tradeoffs between temporal, spatial and SNR resolutions.

Considering the above limitations, a quantitative method to select one of the six scalability operators mentioned earlier for each temporal segment by minimizing an appropriate visual distortion measure (or cost function) is formulated. An objective cost function is defined:
D=α_{block}D_{block}+α_{flat}D_{flat}+α_{blur}D_{blur}+αⱼₑᵣₖDⱼₑᵣₖ
where, α_{block}, α_{flat}, α_{blur}, and αⱼₑᵣₖ are the weighting coefficients for blockiness, flatness, blurriness, and jerkiness measures, respectively. A training procedure is used to determine the coefficients of the cost function according to content type.

FIG. 3 illustrates the proposed system with a fully embedded scalable video coder 301, where each segment is scaled one by one by optimum scaling/encoding operators (SNR—signal to noise ratio, temporal resolution, spatial resolution and their combinations) with respect to a distortion metric which is the linear combination of some flatness, blurriness, blockiness and jerkiness measures. For each segment k, bitstreams formed by different combinations of scalability operators are decoded in block 302. The above objective cost function is evaluated for each combination, and the option that results in the minimum cost function is selected in block 304. The values of coefficients α_{block}, α_{flat}, α_{blur}, and αⱼₑᵣₖ in the cost function are computed for each shot type separately by least squares fitting with the results of subjective tests on some training data. In particular, the coefficients are found such that the value of the objective cost function for some training shots matches subjective visual evaluation scores in the least squares sense. Finally, the optimal bitstream for the segment k is extracted in block 306.

### CONCLUSION

A system and method has been shown in the above embodiments for the effective implementation of a Video Coding and Adaptation by Semantics-Driven Resolution Control for Transport and Storage. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

### APPENDIX

### Multiple-Objective Optimization

A thorough treatment of multiple-objective optimization (MOO) techniques can be found in [1-2]. This appendix presents a simple example to demonstrate the optimal solution generated by a MOO formulation. The MOO problem may be solved as follows:

$${min}_{x , y} \{ f ( x , y ) \} = {min}_{x , y} \{ x \cdot y \}$$

$${min}_{x , y} \{ g ( x , y ) \} = {min}_{x , y} \{ \frac{200}{x} + \frac{200}{y} \}$$

jointly subject to
xε[1,20] and yε[1,20].

[1] H. Papadimitriou, M. Yannakakis, “Multiobjective Query Optimization,” PODS 2001.

[2] Y.-il Lim, P. Floquet, X. Joulia, “Multiobjective optimization considering economics and environmental impact,” ECCE2, Montpellier, 5-7 Oct. 1999.

The sketch of the functions f(x,y) and g(x,y) for the region of interest is shown in FIG. A1.

[image]

The point (x,y)=(1,1) minimizes f with a minimum value of fₘᵢₙ=1 while g attains its maximum value, gₘₐₓ=400 at this point. The other endpoint (x,y)=(20,20) minimizes g with a minimum value of gₘᵢₙ=20, while f attains its maximum value fₘₐₓ=400 at this point. A curve connecting these two points is drawn as follows: K equally spaced samples are taken (K can be chosen to be arbitrarily large) in the interval [fₘᵢₙ, fₘₐₓ]. For every sample, the minimum value that the other cost function g can achieve is found, and plot the curve shown in Figure. An infeasible point that minimizes both of the objective functions individually, the point (fₘᵢₙ=1,gₘᵢₙ=20) for the example presented here, is called the utopia point.

[image]

The best compromise solution is defined as the point on this curve that is closest to the utopia point (f=1, g=20) in the Euclidian-distance sense. For this example, the closest point to the utopia point on this curve can be found as (f=38.21, g=64.71). The corresponding x and y values are determined as x=y=6.181.

1. A method to select optimum spatial resolution (frame size), temporal resolution (frame rate) and SNR (quantization parameter) for encoding each of a plurality of spatio-temporal segments of input video, said method comprising:
classifying each of said plurality of spatio-temporal segments according to content types, and
determining the optimum spatial resolution, temporal resolution, and SNR simultaneously for encoding each spatio-temporal segment based on said content types and one or more optimization criteria.

2. A method to select optimum spatial resolution (frame size), temporal resolution (frame rate) and SNR (quantization parameter), according to claim 1, wherein said optimization criteria is minimization of perceptual distortion or minimization of pre-roll delay or both.

3. A method to select optimum encoding parameters, said encoding parameters comprising, spatial resolution (frame size), temporal resolution (frame rate) and SNR (quantization parameter), using a non-scalable encoder, said method comprising:
dividing input video into a plurality of spatio-temporal segments;
classifying each of said plurality of segments according to content types;
selecting optimum encoding parameters for each of said classified plurality of segments to optimize one or more optimization criteria, and
encoding each of said classified plurality of segments with said optimal encoding parameters.

4. A method to select optimum encoding parameters, according to claim 3, wherein a multiple objective optimization module selects said optimum encoding parameters based on all rate-distortion pairs for each of said classified plurality of segments along with user-defined relevancy levels and available channel bandwidth information.

5. A method to select optimum encoding parameters, according to claim 3, wherein said optimization criteria is minimization of perceptual distortion or minimization of pre-roll delay or both.

6. A method to select optimum scalability parameters, said scalability parameters comprising, spatial resolution (frame size), temporal resolution (frame rate) and SNR (quantization parameter), using a scalable video encoder, said method comprising:
dividing input video into a plurality of segments;
classifying each of said plurality of segments according to content types;
encoding each of said plurality of segments with a scalable encoder;
selecting optimum scalability parameters for each of said classified plurality of segments to optimize one or more optimization criteria, and
extracting a bitstream according to the said optimum scalability parameters.

7. A method to select optimum scalability parameters, according to claim 6, wherein said optimization criteria is. minimization of perceptual distortion or minimization of pre-roll delay or both.

8. A method to select optimum scalability parameters, according to claim 6, wherein a cost function is evaluated to select said optimum scalability parameters.

9. A system to select optimum encoding parameters, said encoding parameters comprising, spatial resolution (frame size), temporal resolution (frame rate) and SNR (quantization parameter), using a non-scalable encoder, said system comprising:
a content analysis component receiving video as input, dividing said video into a plurality of segments and classifying each of said plurality of segments according to content types, and
a content adaptive video encoder component processing said plurality of segments simultaneously or one at a time by selecting optimum encoding parameters for each of said classified plurality of segments to optimize one or more optimization criteria.

10. A system to select optimum encoding parameters, according to claim 9, wherein said optimization criteria is minimization of perceptual distortion or minimization of pre-roll delay or both.

11. A system to select optimum encoding parameters, according to claim 9, wherein said content adaptive video encoder is a non-scalable encoder processing said plurality of segments simultaneously or a scalable encoder processing said plurality of segments one at a time.

12. A system to select optimum encoding parameters, said encoding parameters comprising, spatial resolution (frame size), temporal resolution (frame rate) and SNR (quantization parameter), using a non-scalable encoder, said system comprising:
a content analysis component receiving video as input, dividing said video into a plurality of segments and classifying each of said plurality of segments according to content types;
a pre-processor component converting each of said plurality of segments into a set of pre-selected spatial and temporal resolution format choices;
a content adaptive non-scalable encoder encoding each of said classified plurality of segments with said optimal encoding parameters, said encoder comprising;
a standard encoder encoding each of said pre-selected spatial and temporal resolution format choices of said plurality of segments with encoding parameter sets and outputting a bitstream with rate-distortion pairs for each of said pre-selected spatial and temporal resolution format choices of said segments, and
a multiple objective optimization component selecting said optimum encoding parameters based on said rate-distortion pairs for each of said classified plurality of segments along with user-defined relevancy levels and available channel bandwidth information to optimize one or more optimization criteria.

13. A system to select optimum encoding parameters, according to claim 12, wherein said optimization criteria is minimization of perceptual distortion or minimization of pre-roll delay or both.

14. A system to select optimum encoding parameters, according to claim 12, wherein said non-scalable encoder processes said plurality of segments simultaneously.

15. A system to select optimum encoding parameters, said encoding parameters comprising, spatial resolution (frame size), temporal resolution (frame rate) and SNR (quantization parameter), using a scalable encoder, said system comprising:
a content analysis component receiving video as input, dividing said video into a plurality of segments and classifying each of said plurality of segments according to content types;
a scalable encoder encoding each of said plurality of segements with said optimum encoding parameters with respect to a distortion metric;
a decoder decoding bitstreams formed by different combinations of said encoding parameters for each of said plurality of segements;
a selection component evaluating a cost function for each of said combinations and selecting optimum encoding parameters that minimize said cost function to optimize one or more optimization criteria, and
an extraction component extracting a bitstream according to the said optimum encoding parameters.

16. A system to select optimum encoding parameters, according to claim 15, wherein said distortion metric is the linear combination of flatness, blurriness, blockiness and jerkiness measures.

17. A system to select optimum encoding parameters, according to claim 15, wherein said optimization criteria is minimization of perceptual distortion or minimization of pre-roll delay or both.

18. A system to select optimum encoding parameters, according to claim 15, wherein said non-scalable encoder processes said plurality of segments simultaneously.
